(19) United States
(12) Patent Application Publication
(10) Pub. No.: US 2022/0278510 A1
(43) Pub. Date: Sep. 1, 2022

(54) PATHOGEN TESTING FACILITY AND METHOD OF OPERATING THE SAME

(71) Applicant: Robert BOYKIW, Vancouver (CA)

(72) Inventor: Robert BOYKIW, Vancouver (CA)

(21) Appl. No.: 17/748,396

(22) Filed: May 19, 2022

Related U.S. Application Data
(63) Continuation-in-part of application No. 17/327,293, filed on May 21, 2021.
(60) Provisional application No. 63/029,077, filed on May 22, 2020.

(51) Int. Cl. H01T 23/00; B03C 3/38

(52) U.S. Cl. CPC H01T 23/00; B03C 3/38

(57) ABSTRACT

There is provided a pathogen testing facility according to one aspect. The pathogen testing facility includes a chamber having a plurality of interior surfaces. The pathogen testing facility includes a receptacle positioned within the chamber. The receptacle is shaped to receive at least one of a urine and feces sample for pathogen testing purposes. The pathogen testing facility includes an air ionizer. The pathogen testing facility includes at least one air expelling manifold in fluid communication with the air ionizer. The at least one air expelling manifold is positioned to direct ionized air into the chamber adjacent a first end of at least one said interior surface of the chamber. The pathogen testing facility includes at least one an air collecting manifold positioned adjacent a second end of the at least one said interior surface of the chamber.

### BACKGROUND OF THE INVENTION

### Field of the Invention

There is provided a testing facility. In particular, there is provided a pathogen testing facility and a method of operating the same.

### Description of the Related Art

U.S. Pat. No. 8,388,900 to Benedek discloses an assembly and method for treating or otherwise improving an atmosphere contained within an enclosed space. The enclosed space can be a container such as a bag or other housing for equipment, food and/or suitable material. Ozone is generated within an atmosphere that is exposed to the material. The generated ozone is mixed with the atmosphere. At least a portion of the generated ozone is then removed from the mixed atmosphere. The assembly and method can be used to treat contaminated sports equipment and the like, as well as to treat food storage atmospheres, such as those exposed to fresh fruits and vegetables.

U.S. Pat. No. 8,834,803 to Sunderland discloses a display assembly for containing and displaying perishable products. The display assembly includes a case having at least one wall and defining an internal volume. The display assembly includes a quantity of gas contained in the case. The gas includes ethylene emitted from the perishable products. The display assembly includes an electro hydrodynamic thrust device positioned in the case. The electro hydrodynamic thrust device ionizes a portion of the quantity of gas. The ionized gas includes at least one reactive oxygen species, and the at least one reactive oxygen species reacts with the ethylene to break down the ethylene.

United States Patent Application Publication No. 2002/0150500 A1 to Carman discloses a gaseous blend of Ox and a method for significantly reducing the biological load, including anthrax, on mail and shipping parcels. The gaseous blend of Ox consists at least in part of O₃. The method involves applying a continuous stream of oxygen-containing, i.e., Ox, gas to the mail or shipping parcel at a predetermined temperature, pressure and relative humidity. The continuous stream of Ox gas is prepared in an Ox generation cell, which contains a means for generating the Ox gas at a pressure less than 20 lbs/in2 using, for example, one or more of the following: corona discharge, high frequency electrical discharge, ultraviolet light, x-ray, radioactive isotope and electric beam.

### BRIEF SUMMARY OF INVENTION

There is provided, and it is an object to provide, an improved pathogen testing facility, and method of operating the same.

There is accordingly provided a pathogen testing facility according to one aspect. The pathogen testing facility includes a chamber having a plurality of interior surfaces. The pathogen testing facility includes a receptacle positioned within the chamber. The receptacle is shaped to receive at least one of a urine and feces sample for pathogen testing purposes. The pathogen testing facility includes an air ionizer. The pathogen testing facility includes at least one air expelling manifold in fluid communication with the air ionizer. The at least one air expelling manifold is positioned to direct ionized air into the chamber adjacent a first end of at least one said interior surface of the chamber. The pathogen testing facility includes at least one an air collecting manifold positioned adjacent a second end of the at least one said interior surface of the chamber.

There is also provided a pathogen testing facility according to another aspect. The pathogen testing facility includes a chamber with an entry door and a locked exit door. The pathogen testing facility includes a receptacle positioned within the chamber. The receptacle is shaped to receive at least one of a urine and feces sample from a test subject. The pathogen testing facility includes a testing system configured to test the at least one of the urine and feces sample to detect or determine a likelihood of the presence of one or more target pathogens on or within the test subject. The exit door is configured to only selectively unlocked upon receiving a signal from the testing system that the test subject has received a negative test result for the presence of the one or more target pathogens.

There is further provided a pathogen testing facility according to an additional aspect. The pathogen testing facility includes a chamber including one or more side walls. The pathogen testing facility includes a receptacle positioned within the chamber. The receptacle is shaped to receive at least one of a urine and feces sample for pathogen testing purposes. The pathogen testing facility includes an air ionizer assembly. The air ionizer assembly is configured to direct ionized air from a first end of the one or more side walls to a second end of the one or more side walls. The pathogen testing facility includes an air removal assembly. The air removal assembly is positioned to remove the air so ionized and directed along the one or more side walls.

There is additionally provided a pathogen testing facility according to yet another aspect. The pathogen testing facility includes a chamber. The pathogen testing facility includes a receptacle positioned within the chamber. The receptacle is shaped to receive at least one of a urine and feces sample for pathogen testing purposes. The pathogen testing facility includes an air ionizer assembly. The air ionizer assembly is configured to ionize the air within the chamber after the at least one of the urine and feces sample has been removed from the receptacle. The pathogen testing facility includes an air removal assembly configured to remove the air so ionized.

There is further provided a pathogen testing facility according to yet another aspect. The pathogen testing facility includes a chamber. The pathogen testing facility includes a first status indicator in communication with the chamber and coupled to an entry-side wall of the chamber. The first status indicator is configured to communicate whether the chamber is in use, being cleaned or ready for use, respectively. The pathogen testing facility includes a second status indicator in communication with the chamber and coupled to an exit-side wall of the chamber. The second status indicator is configured to communicate whether a test subject within the chamber has a negative or positive test result for the presence of the one or more target pathogens.

There is also provided pathogen testing facility according to yet an additional aspect. The pathogen testing facility includes a chamber. The pathogen testing facility includes a receptacle positioned within the chamber and shaped to receive at least one of a urine and feces sample for pathogen testing purposes. The pathogen testing facility includes a testing system configured to detect or determine a likelihood of the presence of one or more target pathogens on or within a first test subject by one or more of testing the at least one of the urine and feces sample and testing an interior surface of the chamber. The pathogen testing facility includes a processor in communication with the testing system. The processor is configured to enable the first test subject to exit the chamber only upon determining that the first test subject has a negative test result for the presence of the one or more target pathogens. The pathogen testing facility includes an air ionizer assembly configured to ionize the air within the chamber after the at least one of the urine and feces sample has been removed from the receptacle. The air ionizer assembly is in communication with the processor. The processor is configured to enable a second test subject to enter within the chamber only upon determining that the chamber has been ionized.

The pathogen testing facility as herein described are configured to provide an indication of the presence of a viral respiratory illness according to one embodiment. The pathogen testing facility as herein described is configured to provide an indication of the presence of a common cold, influenza, malaria, a coronavirus and severe acute respiratory syndrome (SARS) in one example.

There is also provide a method of operating a pathogen testing facility. The method includes enabling a test subject to enter within a chamber via an entry door in a first instance to deposit at least one of a urine and feces sample within a receptacle positioned within the chamber. The method includes determining via a testing system whether the test subject has one or more target pathogens by testing the at least one of the urine and feces sample for the presence of one or more indicators of the one or more target pathogens. The method includes unlocking the exit door only upon receiving one or more said signals from the testing system that the test subject has received a negative test result for the presence of the one or more target pathogens.

The method may include directing ionized air within the chamber thereafter so as to pass along interior surfaces of the chamber and couple to and/or disrupt pathogens thereon or adjacent thereto. The method may also include removing the air so ionized and so directed thereafter.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is a front elevation view of a pathogen testing facility according to one aspect;

FIG. 2 is a top plan schematic view thereof with the ceiling of a chamber of the pathogen testing facility being removed to show the interior thereof;

FIG. 3 is a front, right side schematic sectional view of the pathogen testing facility of FIG. 1 taken along lines 3-3 showing details of side walls of the chamber adjacent components of an automated pathogen cleaner of the pathogen testing facility, and with the region between the side walls not being shown;

FIG. 4 is a rear elevation view of the pathogen testing facility of FIG. 1; and

FIG. 5 is a front, right side schematic sectional view similar to FIG. 3 of a pathogen testing facility according to another aspect and showing details of side walls of the chamber adjacent components of an automated pathogen cleaner of the pathogen testing facility, and with the region between the side walls not being shown.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

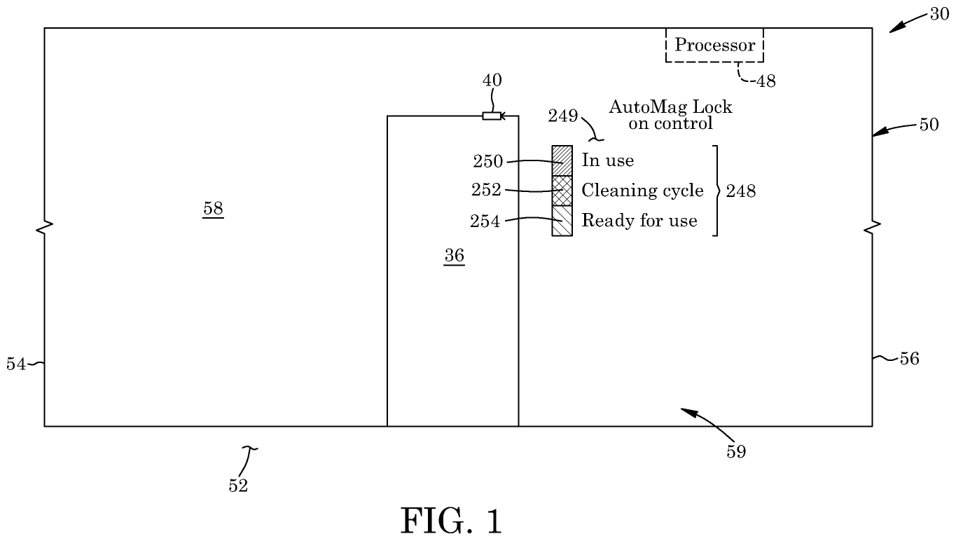

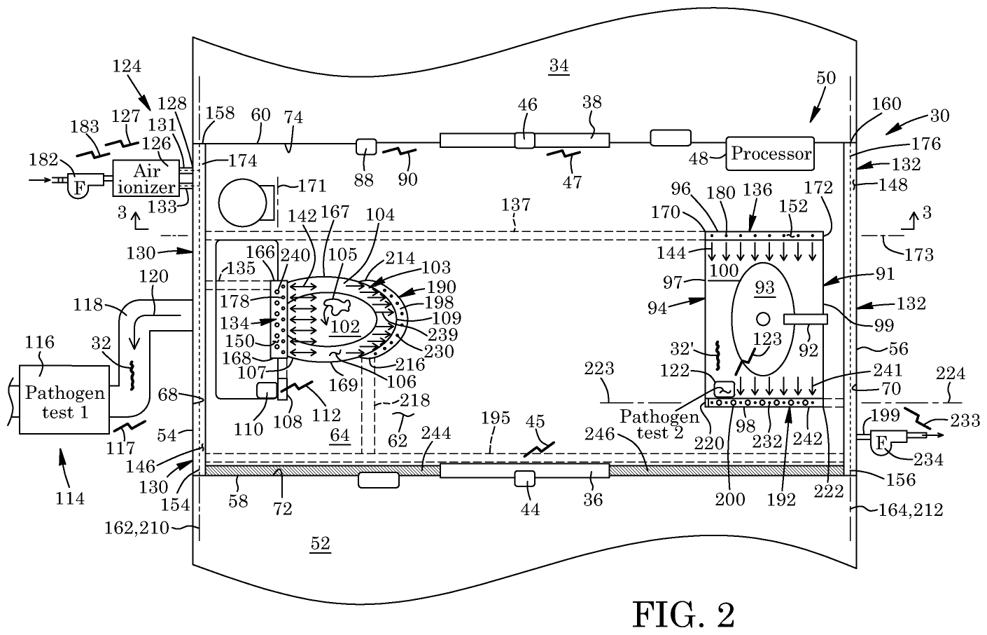

Referring to the drawings and first to FIG. 1, there is shown a pathogen testing facility 30, which may also be referred to as a pathogen detecting facility. Referring to FIG. 2, the pathogen testing facility is configured as an early warning system that detects early indicators of the presence of one or more targeted pathogens 32 and 32′. Pathogen testing facility 30 is configured to inhibit passage of one or more of the targeted pathogens into one or more safe zones 34.

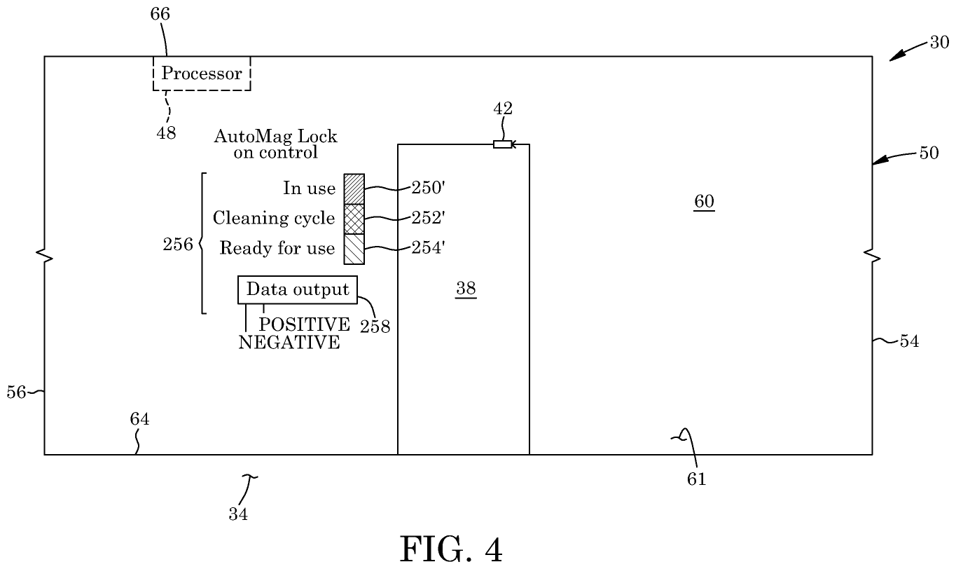

The pathogen testing facility includes an entry door 36 and exit door 38 spaced-apart from the entry door thereof. Each of the doors is a sliding door in this example; however, this is not strictly required. Pathogen testing facility 30 includes at least one and in this example a pair of lock mechanisms, in this example electromagnetic locks for each respective door as seen by lock 40 for entry door 36 seen in FIG. 1 and lock 42 for exit door 38 seen in FIG. 4. However, this is not strictly required and other types of locking mechanism may be used in other embodiments. Also, there may only be one locking mechanism for the exit door in other embodiments. Referring to FIG. 1, each electromagnetic lock 40 is configured to selectively lock and unlock its respective door. As seen in FIG. 4, electromagnetic lock 42 for exit door 38 is configured in a fail secure mode such that the exit door remains locked when power is removed therefrom.

As seen in FIG. 2, pathogen testing facility includes first sensors, in this example entry door sensor 44 and exit door sensor 46. Each door sensor is configured to determine whether the door thereof is open, closed, locked and/or unlocked and send one or more signals 45 and 47 in response thereto. Door sensors 44 and 46 are proximity or position sensors in this example; however, this is not strictly required and other types of sensors may be used in other embodiments. Door sensors, as well as proximity and position sensors, including their various parts and functionings are known per se and therefore will not be described in further detail.

Pathogen testing facility 30 includes a processor 48. The processor is in communication with door sensors 44 and 46 and determines whether doors 36 and 38 are open or closed and locked or unlocked based on the same. Processor 48 is configured to selectively control actuation of electromagnetic locks of the doors from locked to unlocked positions thereof and vice versa.

As seen in FIG. 2, pathogen testing facility 30 includes a chamber 50. The chamber may be a passageway, a room and/or a restroom. The chamber is positioned between an entry or intake zone 52 and one or more safe zones 34. Chamber 50 comprises in this example a checkpoint via which passage to the one or more safes zone is permitted upon determining that one is free of one or more targeted pathogens 32 and 32′. The chamber is configured to function as an early warning system that promotes creating one or more safe zones 34 free of one or more targeted pathogens.

Chamber 50 in this example is a generally rectangular space in top, side, and front profiles; however, this is not strictly required. The chamber includes at least one and in this example a pair of spaced-apart side walls 54 and 56. Chamber 50 in this example includes an entry side or front wall 58 and an exit side or rear wall 60 spaced-apart from the front wall thereof. Side walls 54 and 56 of chamber 50 extend between the front and rear walls of the chamber. Entry door 36 slidably couples to front wall 58 in this example and is configured to selectively open to enable a test subject, in this example a person, to selectively pass therethrough and into interior 62 of chamber 50. Exit door 38 is slidably coupled to rear wall 60 in this example and is configured to selectively open to enable the person to exit out of the chamber. Doors 36 and 38 are centrally positioned between side walls 54 and 56 in this example; however, this is not strictly required. Processor 48 couples to rear wall 60 in this example between exit door 38 and side wall 56; however, this is not strictly required.

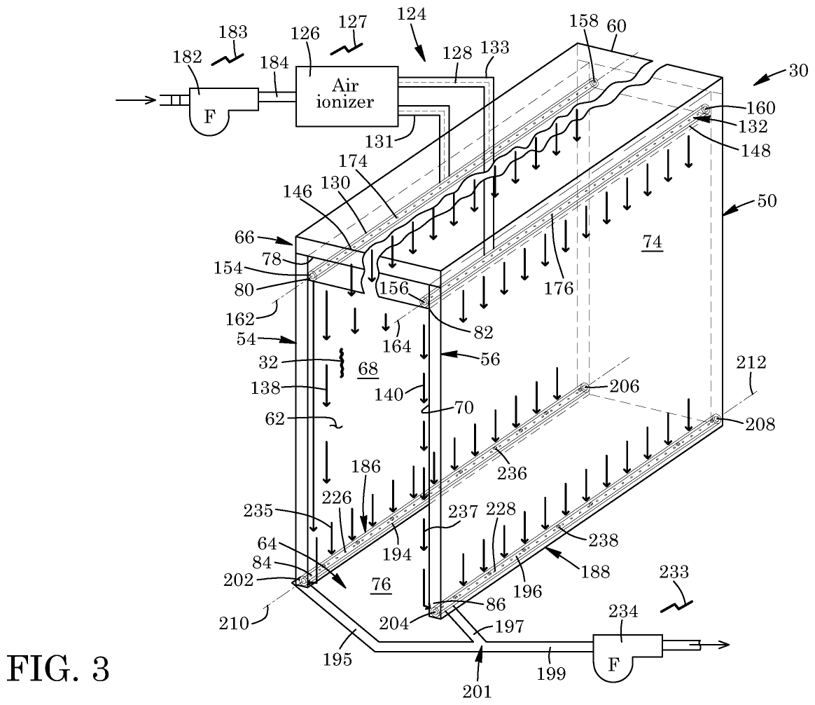

As seen in FIG. 3, the chamber includes a lower surface, in this example a floor 64, and an upper surface, in this example a ceiling 66 spaced-apart from the floor thereof. Walls 54, 56, 58 and 60 of chamber 50 seen in FIG. 2 extend between the floor and ceiling of the chamber in this example. Interior 62 is enclosed by the walls, floor 64 and ceiling 66 of the chamber seen in FIG. 3.

Referring to FIG. 2, chamber 50 has a plurality of interior surfaces that correspond respective ones of the walls, ceiling and floor: interior surfaces 68, 70, 72 and 74 for walls 54, 56, 58 and 60, respectively, and interior surfaces 76 and 78 for floor 64 and ceiling seen in FIG. 3. Each of the interior surfaces has a first end and a second end spaced-apart from the first end thereof. This is shown by side walls 54 and 56 and interior surfaces thereof having first or upper ends or end portions 80 and 82 and second or lower ends 84 and 86 spaced-apart from the upper ends thereof. The upper ends of the side walls are adjacent ceiling 66 of chamber 50. Lower ends 84 and 86 of side walls 54 and 56 are adjacent floor 64 of the chamber.

As seen in FIG. 2, pathogen testing facility 30 includes a second sensor, in this example a test subject sensor 88. The test subject sensor may be referred to as a chamber sensor. Test subject sensor 88 is configured to determine when the person is within interior 62 of chamber 50 and send one or more signals 90 in response thereto. The test subject sensor couples to rear wall 60 in this example near exit door 38; however, this is not strictly required. Test subject sensor 88 is one or more of a proximity (e.g. motion or occupancy), thermal, optical, position, and acoustic said sensor. Processor 48 is in communication with test subject sensor. The processor receives one or more signals from the test subject sensor and determines whether a person is within chamber based on the same. Test subject sensor 88 is not strictly required and processor 48 may, in the alternative, determine that a person is within the chamber based on signals 45 and 47 received by one or more of door sensors 44 and 46 and/or electromagnetic locks 40 and 42 seen in FIGS. 1 and 4, respectively.

Referring back to FIG. 2, pathogen testing facility 30 includes a sink assembly 91 for selectively washing one's hands in this example. The sink assembly includes a faucet 92, sink 93 shaped to receive water from the faucet therewithin, and a vanity top 94 to which the sink is mounted. Sink assembly 91 is in this example positioned within interior 62 of chamber 50 between walls 58 and 60 and adjacent side wall 56; however, this is not strictly required. Vanity top 94 has a first end 96, a second end 98 spaced-apart from the first end thereof, and an upper surface 100 extending between the first end and second end thereof. The upper surface of vanity top may also be referred to as an interior surface of chamber 50. Vanity top 94 has a front 97 and a rear 99 spaced-apart from the front thereof. The front and rear of the vanity top extend between ends 96 and 98 of the vanity top.

As seen in FIG. 2, pathogen testing facility 30 includes a receptacle, in this example a toilet bowl 102 of a toilet 103 positioned within interior 62 of chamber 50. The toilet bowl is shaped to receive at least one of a urine and feces sample 105 for pathogen testing purposes from the person to be tested. A toilet seat 104 including outer surface 106 thereof extend about toilet bowl 102 in this example. When the at least one of the urine and feces sample 105 is received, toilet 103 may be thereafter selectively flushed via toilet handle 108. Toilets, including their various parts and functionings, are known per se and toilet 103 will thus not be described in further detail.

Pathogen testing facility may include a third sensor, in this example a test sample sensor 110. The test sample sensor may be referred to as a receptacle or toilet sensor. Test sample sensor 110 is configured to determine the presence of a test sample, such as at least one of the urine or feces sample 105, and sends one or more signals 112 in response thereto. The test sample sensor may be a proximity, thermal, optical, position, and acoustic said sensor for example and in this case is a position sensor coupled to toilet handle 108.

Processor 48 is in communication with test sample sensor 110. Flushing of toilet 103 signals to the processor that the at least one of the urine and feces sample 105 has been obtained within and removed from toilet bowl 102. Processor 48 receives one or more signals 112 from the test sample sensor and determines whether chamber 50 is in use thereby. The processor may also determine that the chamber needs to be cleaned upon receiving one or more signals indicating that the at least one of the urine and feces sample 105 is being flushed down toilet 103. Chamber 50 may be cleaned thereafter or a predetermined amount of time thereafter, for example. Processor 48 selectively inhibits access to the chamber upon determining that the chamber is in use. The processor also inhibits access to the chamber upon determining that the chamber requires or is in the process of being cleaned. At least entry door 36 of chamber 50 is locked during said predetermined period of time and in this example entry door 36 of the chamber is also locked.

Pathogen testing facility 30 includes a testing system 114 configured to test the at least one of the urine and feces sample 105 to detect or determine a likelihood of the presence of one or more target pathogens 32 on or within the person. The testing system comprises one or more a rapid early detection type tests to detect or determine the likelihood of the presence of one or more target pathogens. Testing system 114 in this example includes a first urine/feces test 116 in the form of one or more of a foam test, an antigen test, a peptide test and an amino acid test to detect or determine the likelihood of the presence of one or more target pathogens. To test at least one of the urine and feces sample 105, the sample is in one example flushed down toilet 103, with the at least one of the urine and feces sample, or water in contact therewith, being tested thereafter downstream of chamber 50; however, this is not strictly required. The at least one of the urine and feces sample, or the water in contact therewith, is tested within a sewer 118 or while being directed as shown by arrow 120 to a septic tank (not shown). Testing system 114 is configured in this example to send one or more signals 117 corresponding to data or results from first urine/feces test 116.

Testing system 114 may in addition include a surface testing apparatus 122, which may be referred to as a second test. The surface testing apparatus is configured to test one or more interior surfaces of chamber 50 for the presence of one or more target pathogens prior to the chamber being cleaned. In this example surface testing apparatus 122 is positioned to test upper surface 100 of vanity top 94; however, this is not strictly required and the surface testing apparatus may test other interior surfaces in other embodiments such as toilet seat 104 for example. Testing system 114 is configured in this example to send one or more signals or outputs 123 corresponding to data or results from surfacing testing apparatus 122. Foam tests, antigen tests, peptide tests, amino acid tests and surface testing apparatuses per se, including their various parts and functionings, are known per se and will therefore not be described in further detail.

Processor 48 is in communication with and receives output from testing system 114. The signals 117 and 123 from the testing system may be an indication of a positive or negative test result for the presence of the one or more target pathogens 32 and 32′. Alternatively, the output/signals may be comprise data that processor 48 receives to determine whether the person has a positive or negative test result for the presence of the one or more target pathogens. In this case, the processor may be configured to determine that the person has a negative test result when both signals (or output/data) 117 from the of the at least one of the urine and feces sample 105 and output/data 123 from of the surface testing apparatus 122 are determined to comprise a negative test result, respectively.

Testing system 114 is configured to provide an indication of at least the presence of a viral respiratory illness involving one or more target pathogens 32 and/or 32′ in this example. Pathogen testing facility 30 is configured to provide an indication of the presence of one or more of a common cold, influenza, malaria, a coronavirus and severe acute respiratory syndrome (SARS) in this example. Pathogen testing facility 30 in one embodiment is configured to detect the excretion of peptide structures of amino acids specific to the antigenic structure of a coronavirus reacting with the person.

Pathogen testing facility 30 includes an automated pathogen cleaner 124. The automated pathogen cleaner is configured to selectively reduce the presence of pathogens 32 and 32′ within chamber 50. In this example automated pathogen cleaner 124 is configured to selectively sterilize the chamber at least in part. Processor 48 is in communication with the automated pathogen cleaner.

Automated pathogen cleaner 124 includes an air ionizer 126. The air ionizer is configured to selectively ionize air 128. Air ionizer 126 is adjacent side wall 54 of chamber 50 in this example; however, this is not strictly required and the air ionizer may be within the chamber or coupled to the chamber in some other manner in other examples. The air ionizer seen in FIG. 2 is in communication with processor 48 in this example and sends one or more signals 127 based on whether it is turned on or not, for example. The processor is configured to selectively control actuation and speed of ionization of air ionizer 126 in this example thereby. Air ionizers per se, including their various parts and functionings thereof, are known per se and will not be described in further detail.

Automated pathogen cleaner 124 includes at least one and in this example a plurality of air expelling manifolds, in this case: first and second air expelling manifolds 130 and 132, third air expelling manifold 134 and fourth air expelling manifold 136. In other embodiments there may be only fewer or more of said air expelling manifolds. For example, in one embodiment there are only side wall air expelling manifolds 130 and 132. In another embodiment there are air expelling manifolds for each wall 54, 56, 58 and 60 of chamber 50. In a further embodiment there are air expelling manifolds for ceiling 66 and/or floor 64 of the chamber seen in FIG. 3.

As seen in FIG. 3, first and second air expelling manifolds 130 and 132 are in fluid communication with air ionizer 126 via connecting conduits 131 and 133. The first and second air expelling manifolds are adjacent upper ends 80 and 82 of side walls 54 and 56 of chamber 50 in this example. First and second air expelling manifolds 130 and 132 are positioned to direct ionized air into the chamber adjacent the upper ends respective ones of interior surfaces 68 and 70 of the chamber, along and adjacent to interior surfaces 68 and 70 side walls 54 and 56, and towards lower ends 84 and 86 of the side walls. This is shown by arrows of numeral 138 and 140.

As seen in FIG. 2, third air expelling manifold 134 is in fluid communication with air ionizer 126 via connecting conduit 135 that in this example extends between the third air expelling manifold and first air expelling manifold 130; however, this is not strictly required. The third air expelling manifold is positioned adjacent toilet 103 in this example. Third air expelling manifold 134 is positioned to align with proximal end 107 of toilet seat 104 and direct ionized air therealong (as seen by arrow 142) towards distal end 109 of the toilet seat.

Still referring to FIG. 2, fourth air expelling manifold 136 is in fluid communication with air ionizer 126 via connecting conduit 137 that in this example extends between the fourth air expelling manifold and first air expelling manifold 130; however this is not strictly required. Air expelling manifolds 130, 132, 134 and 136 are thus in fluid communication with air ionizer 126 and receive ionized air therefrom. The fourth air expelling manifold is positioned adjacent first end 96 of vanity top 94 in this example. Fourth air expelling manifold 136 is configured to direct ionized air (as seen by arrow 144) along upper surface 100 of the vanity top from the first end of the vanity top towards second end 98 of the vanity top. The ionized air so directed may also extend at least in part within sink 93.

Air expelling manifolds 130, 132, 134 and 136 comprises conduits 146, 148, 150 and 152 in this example. Conduits 146 and 148 have first ends 154 and 156 adjacent front wall 58, second ends 158 and 160 spaced-apart from the first ends, and longitudinal axes 162 and 164 extending between the ends thereof. The second ends of conduits 146 and 148 are adjacent rear wall 60 in this example. As seen in FIG. 3, conduit 146 thus extends along the length of side wall 54 and ceiling 66 of chamber 50 and conduit 148 extends along the length of side wall 56 and the ceiling of the chamber in this example.

Conduit 150 has a first end 166 adjacent first side 167 of toilet seat 104, second end 168 spaced-apart from the first end and adjacent second side 169 of the toilet seat in this example, and a longitudinal axis 171 extending between the ends thereof. Longitudinal axes 162, 164 and 171 of conduits 146, 148 and 150 extend parallel to each other in this example; however, this is not strictly required. Conduit 152 has a first end 170 adjacent front 97 of vanity top 94, a second end 172 spaced-apart from the first end and adjacent rear 99 of the vanity top in this example, and a longitudinal axis 173 extend between the ends thereof. Longitudinal axis 173 of conduit 152 extends perpendicular to longitudinal axes 162, 164 and 171 of conduits 146, 148 and 150 in this example; however, this is not strictly required.

Conduits 146, 148, 198 and 200 each have a plurality of longitudinally spaced-apart apertures 174, 176, 178 and 180 extending therein. The apertures are in fluid communication with chamber 50. Each of conduits 146, 148, 198 and 200 is at least partially clear or transparent in this example; however, this is not strictly required.

As seen in FIG. 3, automated pathogen cleaner 124 includes an air pressurizing apparatus, in this example a fan 182 in this example; however, this is not strictly required and other air pressurizing apparatuses may be used in other embodiments such as various air pumps for example. Air ionizer 126, the air expelling manifolds and the fan may be collectively referred to as an air ionizer assembly. Fan 182 is in fluid communication with air ionizer 126 via connecting conduit 184, thereby directing pressurized air through the air ionizer. The fan is thus in fluid communication with at least one and in this example each of air expelling manifolds 130, 132, 134 and 136 seen in FIG. 2. Fan 182 seen in FIG. 2 is in communication with processor 48 in this example and sends one or more signals 183 based on whether it is turned on or not, for example. The processor is configured to selectively control actuation and speed of fan 182 in this example thereby.

Automated pathogen cleaner 124 includes at least one and in this example a plurality of air collecting manifolds, in this case first and second air collecting manifolds 186 and 188 seen in FIG. 3 and third and fourth air collecting manifolds 190 and 192 seen in FIG. 4. Referring to FIG. 3, the first and second air collecting manifolds are adjacent lower ends 84 and 86 of side walls 54 and 56 and interior surfaces 68 and 70 of chamber 50. First and second air collecting manifolds 186 and 188 extend along the length of side walls 54 and 56 adjacent floor 64 of the chamber in this example. As seen in FIG. 2, third air collecting manifold 190 is positioned adjacent toilet 103 in this example, in this case adjacent distal end 109 of toilet seat 104. The third air collecting manifold is arcuate shaped and extends in part about the toilet seat in this example; however, this is not strictly required. Fourth air collecting manifold 192 is positioned adjacent second end 98 of vanity top 94 in this example.

Air collecting manifolds 186 and 188 (seen in FIG. 3) and air collecting manifolds (seen in FIG. 2) comprise conduits 194, 196, 198 and 200, respectively, in this example. Conduits 194 and 196 seen in FIG. 3 have first ends 202 and 204 adjacent front wall 58, second ends 206 and 208 spaced-apart from the first ends, and longitudinal axes 210 and 212 extending between the ends thereof. The second ends of conduits 194 and 196 are adjacent rear wall 60 in this example. As seen in FIG. 3, conduit 194 thus extends along the length of side wall 54 and floor 64 of chamber 50 and conduit 196 extends along the length of side wall 56 and the floor of the chamber in this example. Longitudinal axes 162, 164, 210 and 212 of conduits 146, 148, 194 and 196 extend parallel to each other in this example; however, this is not strictly required. Conduits 194 and 196 are in fluid communication with each other. In this example connecting conduits 195 and 197 couple to and extend from ends 202 and 204 of conduits 194 and 196, respectively and are in fluid communication with connecting conduit 199 via y-shaped junction 201 in this example.

Conduit 198 has a first end 214 adjacent and aligned with first side 167 of toilet seat 104, and a second end 216 spaced-apart from the first end and adjacent and aligned with second side 169 of the toilet seat in this example. Second end 216 of conduit 190 couples to and is in fluid communication with connecting conduit 195 via connecting conduit 218 in this example. Third air collecting manifold 190 is thus in fluid communication with first and second air collecting manifolds 186 and 188 seen in FIG. 3.

Conduit 200 has a first end 220 adjacent front 97 of vanity top 94, a second end 222 spaced-apart from the first end and adjacent rear 99 of the vanity top in this example, and a longitudinal axis 223 extend between the ends thereof. Longitudinal axis 223 of conduit 200 extends perpendicular to longitudinal axes 162, 164, 171, 210, and 212 of conduits 146, 148, 150, 194 and 196 in this example; however, this is not strictly required.

The conduits 194 and 196 (seen in FIG. 3) and conduits 198 and 200 (seen in FIG. 2) of air collecting manifolds 186, 188, 190, and 192 each have a plurality of longitudinally spaced-apart apertures 226, 228, 230 and 232 extending therein. The apertures are in fluid communication with chamber 50. Each of conduits 195, 196, 198 and 200 is at least partially clear or transparent in this example; however, this is not strictly required.

As seen in FIG. 3, automated pathogen cleaner 224 includes an air suctioning apparatus, in this example a fan, in this case an exhaust fan 234. However, this is not strictly required and other air suctioning apparatuses may be used in other embodiments such as air pumps, vacuum cleaner devices or other suction-creating devices for example. Air collecting manifolds 186, 188, 190 and 192 seen in FIGS. 2 and 3 and the exhaust fan may be collectively referred to as an air removal assembly. Exhaust fan 234 is fluid communication with the at least one and in this example each of air collecting manifolds 186, 188, 190 and 192 seen in FIGS. 2 and 3 and promotes the suctioning of air therethrough as seen by arrows 235, 237, 239 and 241. The exhaust fan seen in FIG. 2 is in communication with processor 48 in this example and sends one or more signals 233 based on whether it is turned on or not, for example. The processor is configured to selectively control actuation and speed of exhaust fan 234 in this example thereby.

As seen in FIG. 3, automated pathogen cleaner 224 includes at least one and in this example a plurality of pathogen disrupters 236, 238, 240 and 242 in fluid communication with at least one and in this example each of the air collecting manifolds. Each pathogen disrupter comprises in this example one or more ultraviolet lights configured to emit ultraviolet radiation (e.g. UVA, UVB or UVC lights).

Referring to FIG. 2, automated pathogen cleaner 224 includes vegetation 244 and 246 positioned within chamber 50. The vegetation is configured to assist in maintaining a desired humidity level within the chamber. Vegetation 244 and 246 is positioned to extend along at least one interior surface of the chamber, in this example along interior surface 72 of front wall 58. The vegetation is positioned to extend along and substantively cover the front wall of chamber 50 in this example. Vegetation 244 and 246 comprises high oxygen and negative ion producing plants (e.g. ivy) in this example. Vegetation 244 and 246 comprises one or more crassulacean acid metabolism (CAM) plants in this case. The vegetation is configured such that negative ions thereof may function to also couple to and/or disrupt pathogens 32 and 32′ which may be on or adjacent to interior surface 72 of front wall 58 or otherwise within interior 62 of chamber 50.

In operation and referring to FIG. 3, first and second air expelling manifolds 130 and 132 are configured to direct ionized air (seen by arrows 138 and 140) through apertures 174 and 176 of conduits 146 and 148 substantially along, across and adjacent interior surfaces 68 and 70 from upper ends 80 and 82 thereof to lower ends 202 and 204 thereof. The ionized air so directed along theses path is configured to couple to and/or disrupt pathogens 32 which may be on or adjacent to said surfaces. First and second air collecting manifolds 186 and 188 are positioned to collect and remove the ionized air thereof as seen by arrows 235 and 237, and which may include pathogens coupled thereto and/or disrupted as a result thereof. Air expelling manifolds 130 and 132 are thus configured to direct ionized air at least two of ceiling 78, floor 64 and side walls 54 and 56 of chamber 50 according to one example.

As seen in FIG. 2, third air expelling manifold 136 positioned adjacent first end 96 of vanity top 94 is configured to direct ionized air via apertures 180 of conduit 152 from the first end of the vanity top towards second end 98 of the vanity top as seen by arrow 144. The ionized air so directed along this path may couple to and/or disrupt pathogens 32′ that may be on or adjacent to the vanity top. Third air collecting manifold 192 is positioned to collect and remove the ionized air thereof, which may include pathogens coupled thereto and/or disrupted as a result thereof. The air expelling manifolds are thus configured to direct ionized air along vanity top 94 and one or more of ceiling 66, floor 64, and side walls 54 and 56 of chamber 50 seen in FIG. 3 according to one example.

Referring to FIG. 2, fourth air expelling manifold 134 so positioned adjacent toilet 103 is configured to direct ionized air via apertures 178 of conduit 150 along surface 106 of toilet seat 104 as seen by arrow 142 and at least in part within toilet bowl 102, after the at least one of the urine and the feces sample 105 has been substantially removed from the toilet. The ionized air so directed along this path may couple to and/or disrupt pathogens that may be on or adjacent to the toilet, including toilet seat 104 and toilet bowl 102. Fourth air collecting manifold 190 is positioned to collect and remove the ionized air thereof (as seen by arrow 241), which may include pathogens coupled thereto and/or disrupted as a result thereof.

Referring to FIGS. 2 and 3, automated pathogen cleaner 124 is thus configured to direct ionized air along one or more interior surfaces 68, 70, 106, and 100 of chamber 50 upon the at least one of the urine and feces sample 105 being removed from toilet bowl 102 of toilet 103. As seen in FIG. 3, the automated pathogen cleaner as herein described is thus configured to reduce the presence of pathogens 32 and 32′ within the chamber prior to and after the at least one of the urine and feces sample being received by the toilet as determined by processor 48. The processor is configured to selectively initiated automated pathogen cleaner 124 is configured to direct ionized air along one or more interior surfaces 68, 70, 106 and 100 of chamber 50 as required, such as upon determining that exit door 38 has opened then closed for example. The automated pathogen cleaner is configured to direct ionized air along the one or more interior surfaces of the chamber for a predetermined period of time according to one embodiment.

Vegetation 244 and 246 also promotes the presence of negative ions within interior 62 of chamber 50, including along front wall 58 thereof. The negative ions from the vegetation along the path of the front wall may function to also couple to and/or disrupt pathogens 32′ which may be on or adjacent to the front wall. This too may thereafter be collected by one or more of air collecting manifolds 186, 188, 190 and 192 seen in FIGS. 2 and 3.

As seen in FIG. 1, pathogen testing facility 30 includes a first chamber status indicator, in this example an entrance-side chamber status indicator, in this case a room status indicator 248. The room status indicator is adjacent entry door 36 and is positioned along exterior 59 of front wall 58 of chamber 50 in this example. Processor 48 is in communication with room status indicator 248 as shown by one or more signals 249. The room status indicator comprises a plurality of lights, in this example a first or red light 250, a second or yellow light 252 and a third or green light 254; however, this is not strictly required.

Red light 250 of room status indicator 248 indicates that chamber 50 is in use. Processor 48 is configured in one example to receive one or more signals 90 of test subject sensor 88 seen in FIG. 2, determine that a person is within the chamber thereby and cause red light 254 of the room status indicator seen in FIG. 1 to turn on. In addition or alternatively, the processor may determine that chamber 50 is in use upon receiving one or more signals 45 from door sensor 44 seen in FIG. 2 indicating that entry door 36 has opened in a first instance and thus cause the red light to turn on. In this case a test subject sensor may not strictly be required. In addition or alternatively, processor 48 may determine that the chamber is in use upon receiving one or more signals 112 from test sample sensor 110 indicating at least one of urine or feces sample 105 has been received within toilet bowl 102 and/or has just been flushed down toilet 103. As a further alternative, the processor may determine that chamber 50 is in use upon receiving one or more signals 117 from first urine/feces test 116 and/or one or more signals 123 from surface testing apparatus 122; however, this is not strictly required and such testing may occur during the cleaning cycle after the person has exited the chamber in other embodiments.

Referring back to FIG. 1, yellow light 252 of room status indicator 248 indicates that chamber 50 is being or about to be cleaned. Processor 48 in one example is configured to receive one or more signals from automated pathogen cleaner 124, such as one or more signals 127, 183, and 233 from air ionizer 126, fan 182 and exhaust fan 234, respectively, seen in FIG. 2, and causes the yellow light of the room status indicator seen in FIG. 1 to turn on upon determining that chamber 50 is being or about to be cleaned. In another example, the processor is configured to conclude that the chamber is being cleaned upon receiving one or more signals 45 from entry door 36, one or more signals 47 from exit door 38, and/or one or more signals 90 from test subject sensor 90 and determining therefrom that the person has exited the chamber via entry door or exit door. Referring back to FIG. 1, room status indicator 248 is thus in communication with the automated pathogen cleaner 124 seen in FIG. 2, in this example via processor 48. The automated pathogen cleaner thus signals to room status indicator 248 via the processor when the automated pathogen cleaner is in a cleaning cycle. This is not strictly required and room status indicator 248 and the automated pathogen cleaner may communicate directly with each other in other embodiments.

As seen in FIG. 1, green light 254 of the room status indicator indicates that chamber 50 is ready for use. Automated pathogen cleaner 124 seen in FIG. 2 signals to processor 48 (via one or more of signals 127, 183 and 233 of air ionizer 126, fan 182 and exhaust fan 234, respectively in this example) when the automated pathogen cleaner has completed cleaning cycle thereof in this example. The processor in response thereto causes green light 254 of room status indicator 254 seen in FIG. 1 to turn on, thereby communicating that chamber 50 is cleaned or ready for use once more based on the status thereof. In another example, processor 48 determines that the cleaning cycle is completed after a determined period of time from determining that the cleaning cycle has begun. In a further example and referring to FIG. 2, the processor determines that the cleaning cycle is complete upon having also received one or more signals 45 from door sensor 44 of entry door 36 and/or one or more signals 47 from door sensor 46 of exit door 38. Processor 48 is thus configured to receive one or more signals 45, 47, 90, 112, 117, 123, 127, 183 and 233 from various components (e.g. door sensors 44 and 46, test subject sensor 88, test sample sensor 110, first urine/feces test 116, surface testing apparatus 122, air ionizer 126, fans 182 and 234) of pathogen testing facility 30 and cause respective lights 250, 252 and 254 of room status indicator 248 seen in FIG. 1 to selectively turn on based on the same.

As seen in FIG. 4, pathogen testing facility 30 includes a second chamber status indicator, in this example an exit-side chamber status indicator, in this case a pathogen status indicator 256. The pathogen status indicator may be referred to as a facility or test subject status indicator. Pathogen status indicator 256 is adjacent exit door 38 and positioned along exterior 61 of rear wall 60 of chamber 50 in this example. The pathogen status indicator in this example comprising a plurality of lights, including a green light 250′, a yellow light 252′ and a red light 254′ in this case; however, this is not strictly required. The green lights 250 and 250′, yellow lights 252 and 252′ and red lights 254 and 254′ of indicators 248 and 256 seen in FIGS. 1 and 4 are in communication with each other via processor 48 and communicate the same information in this example.

Processor 48 is in communication with testing system 114 seen in FIG. 2 and may either determine or receive input from the testing system that the person has a negative test result for the presence of the one or more target pathogens 32 and 32′. The processor is configured to cause this information to be displayed via a data output display 258 and/or green light 250′ of pathogen status indicator 256 seen in FIG. 4. Processor 48 may also communicate with and selectively cause electromagnetic lock 42 of exit door 38 to unlock the exit door and enable the person to exit from chamber 50 upon receiving input or determining that the person has received a negative test result for the presence of the one or more target pathogens.

Processor 48 is configured to determine or receive input from testing system 114 seen in FIG. 2 that that the person has a positive test result for the presence of the one or more target pathogens 32 and 32′. The processor is configured to cause this information to be displayed via data output display 258 and/or red light 252′ of pathogen status indicator 256 seen in FIG. 4. In this case, processor 48 actuates lock 42 and/or ensures that exit door 38 remains locked, thereby inhibiting the person from passing through the exit door 38 and into one or more safe zones 34. The exit door is thus only selectively unlocked upon receiving one or more signals 117 of first urine/feces test 116 and/or one or more signals 123 from surface testing apparatus 122 of testing system 114 seen in FIG. 2 that the person has received a negative test result for the presence of the one or more target pathogens. Processor 48 as herein described is thus configured to receive signals from various components of pathogen testing facility 30 and cause access to and cleaning of the pathogen testing facility to be selectively controlled in response thereto. Pathogen status indicator 256 seen in FIG. 4 is thus configured to communicate tests performed, including results thereof and pathogen levels thereof.

Pathogen testing facility 30 is portable at least in part in one embodiment; in one example the pathogen testing facility is fully portable. In another example, chamber 50 of the pathogen testing facility is portable, including contents thereon and therewithin, with first urine/feces test 116 therefor seen in FIG. 2 disposed within the sewer, septic tank or otherwise, being remote and/or a third party system.

As seen in FIG. 2, there is thus provided a method of operating a pathogen testing facility 30. The method includes enabling person to enter within chamber 50 via entry door 36 in a first instance to deposit at least one of the urine and feces sample 105 within toilet bowl 102 of toilet 103 positioned within the chamber. The method includes determining via testing system 114 whether the person has one or more target pathogens 32 by testing the at least one of the urine and feces sample for the presence of one or more indicators of the one or more target pathogens.

The method includes providing chamber 50 with exit door 38 having an electromagnetic lock 42 seen in FIG. 4, with the lock being configured to selectively unlock upon receiving said one or more signals from processor 48. The method includes configuring the electromagnetic lock to be in a fail secure mode such that the exit door remains locked when power is removed therefrom. The method includes unlocking exit door 38 only upon receiving one or more signals 117 and 123 from testing system 114 seen in FIG. 2 that the person has received a negative test result for the presence of the one or more target pathogens 32 and 32′.

As seen in FIG. 3, the method includes providing at least one and in this example a plurality of air expelling manifolds 130 and 132 adjacent upper ends 80 and 82 of side walls 54 and 56 of chamber 50 and via which ionized air 138 and 140 is expelled after the person has completed testing. The method includes positioning each air expelling manifold adjacent ceiling 66 of the chamber.

As seen in FIG. 2, the method includes in this example directing ionized air 144 along vanity top 94 from first end 96 of the vanity top to second end 98 of the vanity top, in this example via further air expelling manifold 136. The method includes in this example directing ionized air 142 within toilet 103 via additional air expelling manifold 134.

Referring back to FIG. 3, the method includes providing at least one and in this example a plurality of air collecting manifolds 186 and 188 positioned adjacent lower ends 84 and 86 of side walls 54 and 56 of chamber 50 to collect the air 235 and 237 so ionized thereafter. The method includes positioning each air collecting manifold adjacent floor 64 of the chamber. As seen in FIG. 2, the method in this example includes providing further air collecting manifold 192 adjacent second end 98 of vanity top 94 to collect air 241 so ionized and passing along the vanity top. The method in this example includes providing additional air collecting manifold 190 adjacent distal end 109 of toilet seat 104 in this example so as to collect air 239 so ionized and passing along the toilet seat and within toilet bowl 102. The method thus includes filling chamber 50 with ionized air (in this example for a predetermined period of time) and thereafter removing the air so ionized between respective persons entry within and using the pathogen testing facility.

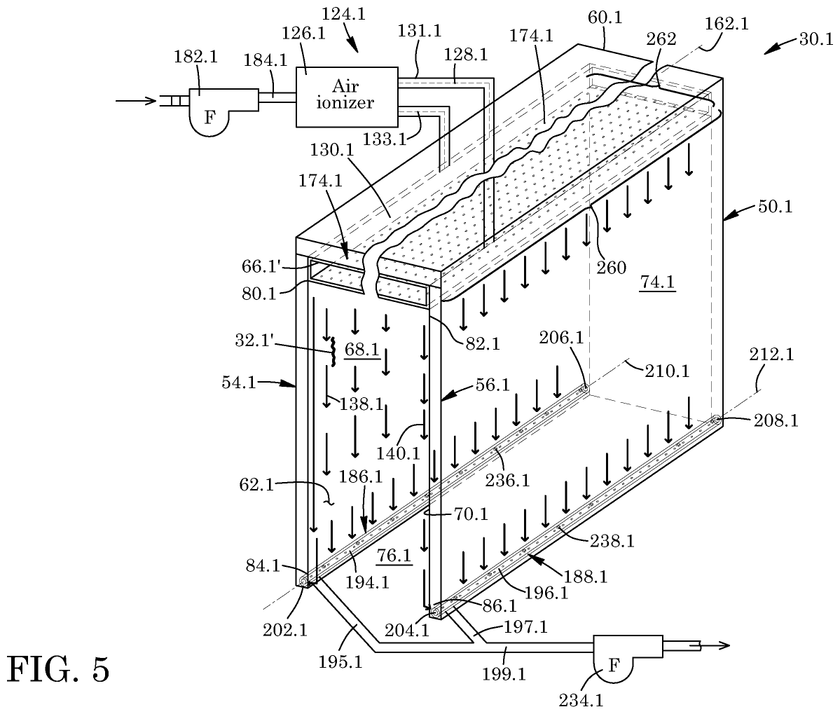

FIG. 5 shows part of a pathogen testing facility 30.1 according to another aspect. Like parts have like numbers and functions as pathogen testing facility 30 shown in FIGS. 1 to 4 with the addition of decimal extension “0.1”. Pathogen testing facility 30.1 is substantially the same as pathogen testing facility 30 shown in FIGS. 1 to 4 with at least the following exceptions.

Air expelling manifold 130.1 spans ceiling 66.1 of chamber 50.1 in this example. The air expelling manifold extends between side walls 54.1 and 56.1 of the chamber and extends between the front and rear walls of the chamber in this example. Apertures 174.1 of air expelling manifold 130.1 are arranged in an array comprising longitudinally-extending columns 260 of laterally spaced-apart rows 262 of apertures spanning chamber 50.1. The air expelling manifold so shaped functions to promote even disbursement downwards of air ionized air across the entire chamber 50, including along and within interior 62.1 of the chamber in regions inwardly spaced from walls 54.1, 56.1 and 60.1 thereof.

It will be appreciated that many variations are possible within the scope of the invention described herein.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

### ADDITIONAL DESCRIPTION

Examples of pathogen testing facilities have been described, as well as methods of using the same. The following clauses are offered as further description.
(1) A pathogen testing facility comprising: a chamber having a plurality of interior surfaces; a receptacle positioned within the chamber and shaped to receive at least one of a urine and feces sample for pathogen testing purposes; an air ionizer; at least one air expelling manifold in fluid communication with the air ionizer and positioned to direct ionized air into the chamber adjacent a first end of at least one said interior surface of the chamber; and at least one an air collecting manifold positioned adjacent a second end of the at least one said interior surface of the chamber.
(2) A pathogen testing facility according to clause 1, or any preceding or subsequent clause, wherein the at least one said interior surface of the chamber is a side wall of the chamber.
(3) A pathogen testing facility according to clause 2, or any preceding or subsequent clause, wherein the first end of the at least one said interior surface of the chamber is adjacent a ceiling of the chamber.
(4) A pathogen testing facility according to any one of clauses 2 to 3, or any preceding or subsequent clause, wherein the second end of the at least one said interior surface of the chamber is adjacent a floor of the chamber.
(5) A pathogen testing facility according to clause 1, or any preceding or subsequent clause, wherein the chamber includes a plurality of spaced-apart side walls, wherein the pathogen testing facility comprises a plurality of said air expelling manifolds adjacent first ends of the side walls, and wherein the pathogen testing facility comprises a plurality of said air collecting manifolds adjacent second ends of the side walls.
(6) A pathogen testing facility according to clause 5, or any preceding or subsequent clause, wherein the first ends of the side walls of the chamber are adjacent a ceiling of the chamber.
(7) A pathogen testing facility according to any one of clauses 5 to 6, or any preceding or subsequent clause, wherein the second ends of the side walls of the chamber are adjacent a floor of the chamber.
(8) A pathogen testing facility according to clause 1, or any preceding or subsequent clause, wherein the at least one said interior surface of the chamber is part of a ceiling of the chamber.
(9) A pathogen testing facility according to clause 1, or any preceding or subsequent clause, wherein the at least one said interior surface of the chamber is part of a floor of the chamber.
(10) A pathogen testing facility according to clause 1, or any preceding or subsequent clause, wherein the chamber includes a ceiling, a floor and one or more side walls, and wherein the at least one air expelling manifold is configured to direct ionized air along two or more of the ceiling, the floor and the one or more side walls of the chamber.
(11) A pathogen testing facility according to clause 1, or any preceding or subsequent clause, wherein the at least one said interior surface of the chamber comprises a vanity top.
(12) A pathogen testing facility according to clause 1, or any preceding or subsequent clause, wherein the pathogen testing facility includes a vanity top, wherein the chamber includes a ceiling, a floor, and one or more side walls, and wherein the at least one air expelling manifold is configured to direct ionized air along the vanity top and along the ceiling, the floor, the one or more side walls of the chamber.
(13) A pathogen testing facility according to any one of clauses 1 to 12, or any preceding or subsequent clause, wherein the at least one air expelling manifold is configured to direct ionized air within the receptacle after the at least one of the urine and the feces sample has been substantially removed from the receptacle.
(14) A pathogen testing facility according to any one of clauses 1 to 13, or any preceding or subsequent clause, including a pathogen disrupter in fluid communication with the at least one said air collecting manifold.
(15) A pathogen testing facility according to clause 14, or any preceding or subsequent clause, wherein the pathogen disrupter comprises one or more ultraviolet lights configured to emit ultraviolet radiation.
(16) A pathogen testing facility according to any one of clauses 1 to 15, or any preceding or subsequent clause, wherein the at least one said air expelling manifold comprises a conduit which extends along at least one of the length of a first wall of the chamber and the length of the ceiling of the chamber.
(17) A pathogen testing facility according to any one of clauses 1 to 16, or any preceding or subsequent clause, wherein the at least said one air collecting manifold comprises a conduit which extends along at least one of the length of the first wall of the chamber and the length of the floor of the chamber.
(18) A pathogen testing facility according to any one of clauses 16 to 17, or any preceding or subsequent clause, where in the chamber includes a second wall and a third wall spaced-apart from the second wall thereof, the first wall of the chamber extending between the second wall and the third wall of the chamber, and wherein each said conduit has a first end adjacent the second wall and a second end spaced-apart from the first end thereof, with the second end of each said conduit being adjacent the third wall of the chamber.
(19) A pathogen testing facility according to any one of clauses 16 to 18, or any preceding or subsequent clause, wherein each said conduit has a plurality of longitudinally spaced-apart apertures extending therein, with the apertures being in fluid communication with the chamber.
(20) A pathogen testing facility according to any one of clauses 16 to 18, or any preceding or subsequent clause, wherein said conduit has a plurality of apertures extending therein, the apertures being in fluid communication with and being arranged in an array spanning the chamber.
(21) A pathogen testing facility according to any one of clauses 16 to 20, or any preceding or subsequent clause, wherein each said conduit is at least partially clear or transparent.
(22) A pathogen testing facility according to any one of clauses 1 to 21, or any preceding or subsequent clause, including an air pressurizing apparatus in fluid communication with the at least one said air expelling manifold.
(23) A pathogen testing facility according to any one of clauses 1 to 22, or any preceding or subsequent clause, including an air suctioning apparatus in fluid communication with the at least one said air collecting manifold.
(24) A pathogen testing facility according to any one of clauses 1 to 23, or any preceding or subsequent clause, wherein the air ionizer, the at least one said air expelling manifold and the at least one said air collecting manifold are configured to selectively reduce the presence of pathogens within the chamber.
(25) A pathogen testing facility according to clause 24, or any preceding or subsequent clause, wherein the air ionizer, the at least one said air expelling manifold and the at least one air collecting manifold are configured to reduce the presence of pathogens within the chamber prior to and after the at least one of the urine and feces sample being received by the receptacle.
(26) A pathogen testing facility according to any one of clauses 24 to 25, or any preceding or subsequent clause, including an automated pathogen cleaner comprising at least said air ionizer, the at least one said air expelling manifold and the at least one said air collecting manifold, the automated pathogen cleaner being configured to selectively sterilize the chamber.
(27) A pathogen testing facility comprising: a chamber with an entry door and a locked exit door; a receptacle positioned within the chamber and shaped to receive at least one of a urine and feces sample from a test subject; and a testing system configured to test the at least one of the urine and feces sample to detect or determine a likelihood of the presence of one or more target pathogens on or within the test subject, whereby the exit door is only selectively unlocked upon receiving a signal from the testing system that the test subject has received a negative test result for the presence of the one or more target pathogens.
(28) A pathogen testing facility according to clause 27, or any preceding or subsequent clause, including an automated pathogen cleaner configured to direct ionized air along one or more interior surfaces of the chamber upon the at least one of the urine and feces sample being removed from the receptacle.
(29) A pathogen testing facility according to clause 28, or any preceding or subsequent clause, wherein the automated pathogen cleaner is configured to direct ionized air along one or more interior surfaces of the chamber upon determining that the exit door has opened then closed.
(30) A pathogen testing facility according to clause 27, or any preceding or subsequent clause, including a sensor configured to determine when a person is within the chamber and send one or more signals in response thereto, and including a chamber status indicator configured to receive said one or more signals of the sensor and communicate in response thereto whether the chamber is in use.
(31) A pathogen testing facility according to clause 30, or any preceding or subsequent clause, wherein the sensor is one or more of a proximity, thermal, optical, position, and acoustic said sensor.
(32) A pathogen testing facility according to clause 30 to 31, or any preceding or subsequent clause, including an automated pathogen cleaner configured to direct ionized air along one or more interior surfaces of the chamber upon the at least one of the urine and feces sample being removed from the receptacle, and wherein the chamber status indicator is in communication with the automated pathogen cleaner and communicates that the chamber is being cleaned or ready for use once more based on the status thereof.
(33) A pathogen testing facility according to clause 32, or any preceding or subsequent clause, wherein the automated pathogen cleaner signals to the chamber status indicator when the automated pathogen cleaner is in a cleaning cycle and wherein the automated pathogen cleaner signals to the chamber status indicator when the automated pathogen cleaner has completed said cleaning cycle.
(34) A pathogen testing facility according to any one of clauses 32 to 33, or any preceding or subsequent clause, wherein the automated pathogen cleaner is configured to direct ionized air along one or more interior surfaces of the chamber upon determining that the exit door has opened then closed.
(35) A pathogen testing facility according to any one of clauses 32 to 34, or any preceding or subsequent clause, wherein the automated pathogen cleaner directs ionized air along the one or more interior surfaces of the chamber for a predetermined period of time.
(36) A pathogen testing facility according to clause 35, or any preceding or subsequent clause, wherein at least the entry door of the chamber is locked during said predetermined period of time.
(37) A pathogen testing facility according to any one of clauses 30 to 36, or any preceding or subsequent clause, wherein the chamber status indicator is adjacent the entry door.
(38) A pathogen testing facility according to any one of clauses 30 to 37, or any preceding or subsequent clause, wherein the chamber status indicator determines via a processor thereof that the chamber is in use upon the entry door opening in a first instance.
(39) A pathogen testing facility according to clause 38, or any preceding or subsequent clause, wherein the chamber status indicator determines via the processor thereof that the chamber is being cleaned upon determining that the person has exited the chamber.
(40) A pathogen testing facility according to any one of clauses 30 to 39, or any preceding or subsequent clause, wherein the chamber status indicator comprises a plurality of lights.
(41) A pathogen testing facility according to any one of clauses 30 to 39, or any preceding or subsequent clause, wherein the chamber status indicator includes a red light which turns on when the chamber is in use, a yellow light which turns on when the chamber being cleaned, and a green light which turns on when the chamber is ready for use.
(42) A pathogen testing facility according to any one of clauses 30 to 41, or any preceding or subsequent clause, wherein the chamber status indicator comprises an entrance-side said chamber status indicator, and wherein the pathogen testing facility includes an exit-side said chamber status indicator in configured to communicate tests performed, including results thereof and pathogen levels thereof.
(43) A pathogen testing facility according to any one of clauses 1 to 42, or any preceding or subsequent clause, further including a surface testing apparatus configured to test one or more surfaces of the chamber for the presence of one or more target said pathogens prior to the chamber being cleaned.
(44) A pathogen testing facility according to any one of clauses 27 to 43, or any preceding or subsequent clause, including an electromagnetic lock that selectively locks and unlocks the exit door, the electromagnetic lock being configured in a fail secure mode such that the exit door remains locked when power is removed therefrom.
(45) A pathogen testing facility comprising: a chamber including one or more side walls; a receptacle positioned within the chamber and shaped to receive at least one of a urine and feces sample for pathogen testing purposes; an air ionizer assembly configured to direct ionized air from a first end of the one or more side walls to a second end of the one or more side walls; and an air removal assembly positioned to remove the air so ionized and directed along the one or more side walls thereafter.
(46) A pathogen testing facility according to clause 45, or any preceding or subsequent clause, including a vanity top, wherein the air ionizer assembly is configured to direct ionized air from a first end of the vanity top to a second end of the vanity top, with the air removal assembly removing the air so ionized and directed along the vanity top thereafter.
(47) A pathogen testing facility according to any one of clauses 45 to 46, or any preceding or subsequent clause, wherein the air ionizer assembly is configured to direct ionized air within the receptacle after the at least one of a urine and feces sample has been substantially removed from the receptacle, with the air removal assembly removing the air so ionized and directed within the receptacle thereafter.
(48) A pathogen testing facility comprising: a chamber; a receptacle positioned within the chamber and shaped to receive at least one of a urine and feces sample for pathogen testing purposes; an air ionizer assembly configured to ionize the air within the chamber after the at least one of the urine and feces sample has been removed from the receptacle; and an air removal assembly configured to remove the air so ionized thereafter.
(49) A pathogen testing facility according to any one of clauses 1 to 48, or any preceding or subsequent clause, including vegetation positioned within the chamber.
(50) A pathogen testing facility according to clause 49, or any preceding or subsequent clause, wherein the vegetation is positioned to extend along the at least one said interior surface of the chamber.
(51) A pathogen testing facility according to any one of clauses 49 to 50, or any preceding or subsequent clause, wherein the vegetation extends along an entry side wall and is configured to assist in maintaining a desired humidity level within the chamber.
(52) A pathogen testing facility according to any one of clauses 49 to 50, or any preceding or subsequent clause, wherein the vegetation is positioned to extend along and substantively cover the side walls of the chamber.
(53) A pathogen testing facility according to any one of clauses 49 to 52, or any preceding or subsequent clause, wherein the vegetation comprises high oxygen and negative ion producing plants.
(54) A pathogen testing facility according to any one of clauses 49 to 53, or any preceding or subsequent clause, wherein the vegetation comprises one or more crassulacean acid metabolism (CAM) plants.
(55) A pathogen testing facility according to any one of clauses 1 to 54, or any preceding or subsequent clause, including a processor configured to receiving signals from various components of the facility and cause access to and cleaning of the chamber to be selectively controlled in response thereto.
(56) A pathogen testing facility according to any one of clauses 1 to 55, or any preceding or subsequent clause, wherein the chamber is a passageway.
(57) A pathogen testing facility according to any one of clauses 1 to 55, or any preceding or subsequent clause, wherein the chamber is a room.
(58) A pathogen testing facility according to any one of clauses 1 to 55, or any preceding or subsequent clause, wherein the chamber is a restroom.
(59) A pathogen testing facility according to any one of clauses 1 to 58, or any preceding or subsequent clause, wherein the receptacle is part of a toilet.
(60) A pathogen testing facility according to clause 59, or any preceding or subsequent clause, wherein the at least one of the urine and feces sample is flushed down the toilet, with the at least one of the urine and feces sample, or water in contact therewith, being tested thereafter downstream of the chamber.
(61) A pathogen testing facility according to clause 60, or any preceding or subsequent clause, wherein the at least one of the urine and feces sample, or the water in contact therewith, is tested within a sewer or while being directed to a septic tank.
(62) A pathogen testing facility comprising: a chamber; a first status indicator in communication with the chamber and coupled to an entry-side wall of the chamber, the first status indicator being configured to communicate whether the chamber is in use, being cleaned or ready for use, respectively; and a second status indicator in communication with the chamber and coupled to an exit-side wall of the chamber, the second status indicator being configured to communicate whether a test subject within the chamber has a negative or positive test result for the presence of the one or more target pathogens.
(63) A pathogen testing facility of clause 62, or any preceding or subsequent clause, including an entrance door which enables a test subject to enter within the chamber only upon the first status indicator communicating that the chamber is ready for use.
(64) A pathogen testing facility of any one of clauses 62 to 63, or any preceding or subsequent clause, including an exit door which enables a test subject to exit the chamber only upon the second status indicator communicating that the test subject has a positive test result for the presence of the one or more target pathogens.
(65) A pathogen testing facility of any one of clauses 62 to 64, or any preceding or subsequent clause, including electromagnetic locks in communication with the status indicators.
(66) A pathogen testing facility of any one of clauses 62 to 65, or any preceding or subsequent clause, including a testing system within the chamber which tests at least one of a urine or feces sample and thereby detects or determines a likelihood of the presence of one or more target pathogens on or within the test subject.
(67) A pathogen testing facility of any one of clauses 62 to 66, or any preceding or subsequent clause, including a testing system which tests one or more interior surfaces of the chamber and detects or determines a likelihood of the presence of one or more target pathogens on or within the test subject.
(68) A pathogen testing facility of any one of clauses 62 to 66, or any preceding or subsequent clause, including a testing system comprises a first test of one or more interior surfaces of the chamber and a second test of at least one of a urine or feces sample, the testing system being configured to determine that the test subject has a positive test result for the presence of one or more target pathogens if at least one said test detects or determines a likelihood of the presence of one or more target pathogens on or within the test subject.
(69) A pathogen testing facility comprising: a chamber; a receptacle positioned within the chamber and shaped to receive at least one of a urine and feces sample for pathogen testing purposes; a testing system configured to detect or determine a likelihood of the presence of one or more target pathogens on or within a first test subject by one or more of testing the at least one of the urine and feces sample and testing an interior surface of the chamber; a processor in communication with the testing system, the processor being configured to enable the first test subject to exit the chamber only upon determining that the first test subject has a negative test result for the presence of the one or more target pathogens; and an air ionizer assembly configured to ionize the air within the chamber after the at least one of the urine and feces sample has been removed from the receptacle, the air ionizer assembly being in communication with the processor and the processor being configured to enable a second test subject to enter within the chamber only upon determining that the chamber has been ionized.
(70) A pathogen testing facility according to clause 69, or any subsequent or preceding clause, wherein the chamber includes an exit door with a locking mechanism, wherein the pathogen testing facility includes a receptacle sensor configured to determine when the at least one of the urine and feces samples has been removed from the receptacle, and wherein the processor is in communication with the locking mechanism, the receptacle sensor and the testing system, with the processor being configured to unlock the exit door to enable the test subject to exit the chamber only upon determining via the receptacle sensor that the at least one of the urine and feces sample has been removed and that the test subject has said negative test result for the presence of the one or more target pathogens; and
(71) A pathogen testing facility according to any one of clauses 69 to 70, or any subsequent or preceding clause, wherein the testing system includes testing one or more interior surfaces of the chamber to detect or determine a likelihood of the presence of one or more target pathogens on or within a first test subject.
(72) A pathogen testing facility according to clause 71, or any subsequent or preceding clause, wherein the chamber includes an entry door with a locking mechanism, wherein the processor is in communication with the locking mechanism of the entry door, and wherein the processor upon determining that a given said test subject is within the chamber and that the entry door is closed, causes the testing system to test the one or more said interior surfaces of the chamber.
(73) A pathogen testing facility according to any one of clauses 1 to 72, or any preceding or subsequent clause, wherein the pathogen testing facility is configured to be portable.
(74) A pathogen testing facility according to any one of clauses 1 to 73, or any preceding or subsequent clause, wherein the chamber is configured to function as an early warning system
(75) A pathogen testing facility according to any one of clauses 1 to 73, or any preceding or subsequent clause, wherein the chamber is used as an early warning system which promotes creating one or more safe zones free of one or more targeted said pathogens.
(76) A pathogen testing facility according to any one of clauses 1 to 73, or any preceding or subsequent clause, wherein the facility is configured as an early warning system that detects early indicators of the presence of one or more targeted said pathogens.
(77) A pathogen testing facility according to clause 76, or any preceding or subsequent clause, wherein the pathogen testing facility is configured to inhibit passage of one or more targeted said pathogens into one or more safe zones.
(78) A pathogen testing facility according to any one of clauses 1 to 74, or any preceding or subsequent clause, wherein the chamber comprises a checkpoint via which passage to a safe zone is permitted upon determining that one is free of one or more targeted said pathogens.
(79) A pathogen testing facility according to any one of clauses 1 to 78, or any preceding or subsequent clause, wherein the facility is configured to provide an indication of the presence of a viral respiratory illness.
(80) A pathogen testing facility according to any one of clauses 1 to 79, or any preceding or subsequent clause, wherein the facility is configured to provide an indication of the presence of a common cold, influenza, malaria, a coronavirus and severe acute respiratory syndrome (SARS).
(81) A pathogen testing facility according to any one of clauses 1 to 80, or any preceding or subsequent clause, wherein the facility includes one or more a rapid early detection type tests to detect or determine the likelihood of the presence of one or more target said pathogens.
(82) A pathogen testing facility according to any one of clauses 1 to 81, or any preceding or subsequent clause, wherein the facility includes one or more of a foam test, an antigen test, a peptide test and an amino acid test to detect or determine the likelihood of the presence of one or more target said pathogens.
(83) A pathogen testing facility according to any one of clauses 1 to 82, or any preceding or subsequent clause, wherein the facility is configured to detect the excretion of peptide structures of amino acids specific to the antigenic structure of a coronavirus reacting with the test subject.
(84) A method of operating a pathogen testing facility having an entry door and a locked exit door, the method comprising: enabling a test subject to enter within a chamber via the entry door in a first instance to deposit at least one of a urine and feces sample within a receptacle positioned within the chamber; determining via a testing system whether the test subject has one or more target pathogens by testing the at least one of the urine and feces sample for the presence of one or more indicators of the one or more target pathogens; and unlocking the exit door only upon receiving one or more said signals from the testing system that the test subject has received a negative test result for the presence of the one or more target pathogens.
(85) A method according to clause 84, or any preceding or subsequent clause, including: providing the exit door with an electromagnetic lock configured to selectively unlock upon receiving said one or more signals.
(86) A method according to clause 85, or any preceding or subsequent clause, including configuring the electromagnetic lock to be in a fail secure mode such that the exit door remains locked when power is removed therefrom.
(87) A method according to any one of clauses 83 to 85, or any preceding or subsequent clause, including: filling the chamber with ionized air for a predetermined period of time and thereafter removing the air so ionized between respective said test subjects.
(88) A method according to any one of clauses 83 to 87, or any preceding or subsequent clause, including: providing at least one air expelling manifold adjacent a first end of at least one interior surface of the chamber and via which ionized air is expelled; and providing at least one an air collecting manifold positioned adjacent a second end of the at least one said interior surface of the chamber to collect the air so ionized thereafter.
(89) A method according to any one of clauses 83 to 87, or any preceding or subsequent clause, including: providing one or more air expelling manifolds adjacent first ends of side walls of the chamber and via which ionized air is expelled; and providing one or more an air collecting manifolds positioned adjacent second ends of the side walls of the chamber to collect the air so ionized thereafter.
(90) A method according to any one of clauses 88 to 89, or any preceding or subsequent clause, including: positioning each said air expelling manifold adjacent a ceiling of the chamber; and positioning each said air collecting manifold adjacent a floor of the chamber.
(91) A method according to any one of clauses 83 to 90, or any preceding or subsequent clause, wherein a vanity top is positioned within the chamber, and the method includes: directing ionized air along the vanity top from a first end of the vanity top to a second end of the vanity top.
(92) Apparatus including any new and inventive feature, combination of features, or sub-combination of features as described herein.
(93) Methods including any new and inventive steps, acts, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A pathogen testing facility comprising:
a chamber;
a receptacle positioned within the chamber and shaped to receive at least one of a urine and feces sample for pathogen testing purposes;
an air ionizer assembly configured to ionize the air within the chamber; and
an air removal assembly configured to remove the air so ionized thereafter.

2. A pathogen testing facility according to claim 1, wherein the air ionizer assembly is configured to direct ionized air from a first end of one or more side walls of the chamber to a second end of the one or more side walls of the chamber.

3. A pathogen testing facility according to claim 1, wherein the chamber has a plurality of interior surfaces, wherein the air ionizer assembly includes an air ionizer, wherein the air ionizer assembly includes at least one air expelling manifold in fluid communication with the air ionizer and positioned to direct ionized air into the chamber adjacent a first end of at least one said interior surface of the chamber, and wherein the air removal assembly includes at least one an air collecting manifold positioned adjacent a second end of the at least one said interior surface of the chamber.

4. A pathogen testing facility according to claim 1, wherein the chamber includes a ceiling, a floor and one or more side walls, and wherein the air ionizer assembly is configured to direct ionized air along two or more of the ceiling, the floor and the one or more side walls of the chamber.

5. A pathogen testing facility according to claim 1, wherein the pathogen testing facility includes a vanity top, wherein the chamber includes a ceiling, a floor, and one or more side walls, and wherein the air ionizer assembly is configured to direct ionized air along the vanity top and along the ceiling, the floor, the one or more side walls of the chamber.

6. A pathogen testing facility according to claim 1, including at least one air collecting manifold and a pathogen disrupter in fluid communication with the at least one air collecting manifold.

7. A pathogen testing facility according to claim 1, including at least one air collecting manifold that one or more of: extends along at least one of the length of a wall of the chamber; and is at least partially clear or transparent.

8. A pathogen testing facility according to claim 1, wherein the air ionizer assembly includes an air expelling manifold having a plurality of apertures extending therein, the apertures of the air expelling manifold being in fluid communication with and being arranged in an array spanning the chamber.

9. A pathogen testing facility according to claim 1, including vegetation positioned to extend along at least one interior surface of the chamber, the vegetation being configured to assist in maintaining a desired humidity level within the chamber and comprising high oxygen and negative ion producing plants.

10. A pathogen testing facility according to claim 1, wherein the chamber is one of a passageway or a restroom.

11. A pathogen testing facility according to claim 1, wherein the air ionizer assembly is configured to ionize the air within the chamber after the at least one of the urine and feces sample has been removed from the receptacle.

12. A pathogen testing facility according to claim 1, wherein the at least one of the urine and feces sample, or water in contact therewith, is tested within a sewer or while being directed to a septic tank.

13. A pathogen testing facility according to claim 1, wherein the facility is configured to provide an indication of the presence of one or more of: a viral respiratory illness, a common cold, influenza, malaria, a coronavirus and severe acute respiratory syndrome (SARS).

14. A pathogen testing facility comprising:
a chamber;
a first status indicator in communication with the chamber and coupled to an entry-side wall of the chamber, the first status indicator being configured to communicate whether the chamber is in use, being cleaned or ready for use, respectively; and
a second status indicator in communication with the chamber and coupled to an exit-side wall of the chamber, the second status indicator being configured to communicate whether a test subject within the chamber has a negative or positive test result for the presence of one or more target pathogens.

15. A pathogen testing facility according to claim 14, including a sensor configured to determine when a test subject is within the chamber and send one or more signals in response thereto, with the first status indicator being configured to receive said one or more signals of the sensor and communicate in response thereto whether the chamber is in use.

16. A pathogen testing facility comprising:
a chamber with an entry door and a locked exit door;
a receptacle positioned within the chamber and shaped to receive at least one of a urine and feces sample from a test subject;
a testing system configured to detect or determine a likelihood of the presence of one or more target pathogens on or within a test subject by one or more of testing the at least one of the urine and feces sample and testing an interior surface of the chamber; and
a processor in communication with the testing system and causing the exit door to selectively unlock upon receiving a signal from the testing system that the test subject has received a negative test result for the presence of the one or more target pathogens.

17. A pathogen testing facility according to claim 16, including an electromagnetic lock that selectively locks and unlocks the exit door, the electromagnetic lock being configured in a fail secure mode such that the exit door remains locked when power is removed therefrom.

18. A pathogen testing facility according to claim 16, including an air ionizer assembly configured to ionize the air within the chamber after the at least one of the urine and feces sample has been removed from the receptacle, the air ionizer assembly being in communication with the processor and the processor being configured to enable a second said test subject to enter within the chamber only upon determining that the chamber has been ionized.

19. A method of operating the pathogen testing facility of claim 16, the method comprising:
enabling the test subject to enter within the chamber via the entry door in a first instance to deposit at least one of a urine and feces sample within the receptacle positioned within the chamber;
determining via the testing system whether the test subject has one or more target pathogens by one or more of testing the at least one of the urine and feces sample and testing an interior surface of the chamber; and
unlocking the exit door only upon receiving one or more signals from the testing system that the test subject has received a negative test result for the presence of the one or more target pathogens.

20. A method according to claim 19, including the step of:
filling the chamber with ionized air for a predetermined period of time and thereafter removing the air so ionized between respective said test subjects.
